(19) United States
(12) Patent Application Publication
(10) Pub. No.: US 2025/0117248 A1
(43) Pub. Date: Apr. 10, 2025

(54) SYSTEM AND METHOD FOR SYNCHRONIZED MULTI-THREADED EXTRACTION OF HISTORICAL DATA IN WORKFLOW AUTOMATION PLATFORM ARCHITECTURES

(71) Applicant: BANK OF AMERICA CORPORATION, Charlotte, NC (US)

(72) Inventors: Raj Surpur, Flower Mound, TX (US); Kashinath Gande, Frisco, TX (US); Lekshan Jayasinghe, Frisco, TX (US); Sai Saran Tripathy, McKinney, TX (US); Arun Chowdary Narne, Hyderabad (IN); Chandan Kumar, Mumbai (IN)

(73) Assignee: BANK OF AMERICA CORPORATION, Charlotte, NC (US)

(21) Appl. No.: 18/378,500

(22) Filed: Oct. 10, 2023

(51) Int. Cl. G06F 9/48; G06F 9/50

(52) U.S. Cl. CPC G06F 9/4881; G06F 9/5038; G06F 9/505

(57) ABSTRACT

Systems, computer program products, and methods are described herein for extraction of historical data in workflow automation platform architectures. The present disclosure is configured to introduce an advanced approach to historical data extraction from workflow automation platform architectures. At its core, it employs parallel processing, utilizing a multi-threaded asynchronous tool specifically designed within a workflow automation platform architecture framework. This ensures high performance and scalability, enabling easy extraction of large data volumes within designated system maintenance windows without impinging on system performance.

### TECHNOLOGICAL FIELD

Example embodiments of the present disclosure relate to extraction of historical data in workflow automation platform architectures.

### BACKGROUND

To facilitate advanced analytics and reporting, there is a need to integrate workflow automation platform architectures case and workflow historical data into a comprehensive reporting platform. Typically, workflow automation platform architectures retain case and workflow information in a unique, proprietary binary format. This presents a challenge for organizations aiming to leverage this data for analytical purposes as it necessitates the extraction of this data in a normalized dataset form.

Possessing the capability to analyze historical case data from workflow automation platform architecture applications is paramount. This data forms the foundation for deriving actionable insights into current operational processes for many entities. Furthermore, it empowers entities to discern patterns and trends, pinpoint operational inefficiencies, maintain regulatory compliance, and devise strategies to mitigate potential issues.

Applicant has identified a number of deficiencies and problems associated with extraction of historical data in workflow automation platform architectures. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for extraction of historical data in workflow automation platform architectures. The present invention introduces an advanced approach to historical data extraction from workflow automation platform architectures. At its core, it employs parallel processing, utilizing a multi-threaded asynchronous tool specifically designed within a workflow automation platform architecture framework. This ensures high performance and scalability, enabling easy extraction of large data volumes within designated system maintenance windows without impinging on system performance. A key highlight is its reusability; the system framework is architected as a modular workflow automation platform component, allowing seamless integration into various workflow automation platform applications without the necessity for additional coding.

From a configurability standpoint, a user interface (UI) has been devised to facilitate the configuration of record extractions per system node, complemented by a bulk upload feature. Monitoring of the process has been simplified with the UI, offering insights into execution metrics such as status, durations, and other relevant data. Additionally, the system boasts an automated notification feature, where email alerts are triggered in the event of data extraction job failures. To further ensure data integrity, a reconciliation report comparing source and destination data is incorporated.

In some embodiments, implementation of the present invention generally includes the steps of generating a data extract configuration based on received extraction parameters; initiating multiple job scheduler nodes, each configured to generate and execute a plurality of data requests based on the received extraction parameters; applying parallel processing multi-threading engine to concurrently process the plurality of data requests; translating proprietary format extracts into normalized data format extracts; and storing the normalized data format extracts in a designated database.

In some embodiments, the invention further comprises generating and transmitting a user interface to a user device, wherein the user interface comprises a status and completion percentage of each of the multiple job scheduler nodes and corresponding data requests in real-time

In other embodiments, the invention further comprises monitoring a status and completion percentage of each of the multiple job scheduler nodes and corresponding data requests in real-time.

In some embodiments, the invention further comprises triggering automated alerts in case of a data extraction job failure detected during an extraction process.

In some embodiments, the invention further comprises dynamically adjusting a total number of active threads or processes based on a current system load and extraction requirements according to the data extract configuration.

In some embodiments, the parallel processing multi-threading engine further comprises a distributed cloud computing system enabling a concurrent execution of data extraction tasks across multiple hardware nodes.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for extraction of historical data in workflow automation platform architectures, in accordance with an embodiment of the disclosure;

FIG. 2 illustrates a process flow 200 for extraction of historical data in workflow automation platform architectures, in accordance with an embodiment of the disclosure; and

FIG. 3 illustrates a process flow 300 for parallel processing data extraction of historical data in workflow automation platform architectures, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, a “workflow automation platform” may refer to a system or software framework that facilitates the design, execution, and management of various interrelated tasks within an entity or organizational process. This platform typically integrates multiple tasks, tools, and systems into a cohesive flow, ensuring that interactions between tasks are seamless and efficient. It can monitor, control, and optimize user interactions and system operations, ensuring that tasks are executed in the correct sequence and that any dependencies are adequately addressed. Such platforms might also incorporate features for tracking, analyzing, and reporting on the performance of workflows, providing valuable insights for continuous improvement. Moreover, it may cater to both human-to-human, human-to-machine, and machine-to-machine interactions, ensuring a holistic approach to automation within an organization. Furthermore, the “workflow automation platform” as referenced in this context, may include a comprehensive software suite tailored for the management and optimization of entity processes and customer relationships. This platform encompasses tools that enable entities to define, automate, and enhance operational processes through intuitive drag-and-drop functionalities, negating the need for extensive coding. The workflow automation platform may integrate customer relationship management (CRM) solutions, ensuring consistent and personalized customer interactions across all channels. In some embodiments, the platform may excel in case management, handling multifaceted transactions and customer inquiries. To augment automation, it assimilates with robotic process automation tools, mitigating repetitive tasks and human error. By use of AI and machine learning capabilities, the platform provides data-driven guidance for optimal decision-making. Furthermore, with cloud-based offerings, it ensures scalability and adaptability without the constraints of extensive on-premises infrastructure. Its agility and low-code to no-code development approach facilitate rapid application development, making it a responsive tool for ever-evolving entity needs.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “user interface” (UI) refers to the space where interactions between humans and machines occur, aiming to facilitate an effective operation and control of a machine from the user end. This interface may encompass both the tangible elements, like buttons and touchscreens of a device, and the intangible elements, like visual layout, response time, and components of the user experience. In some embodiments, the UI is the bridge that conveys a system functionality to users, ensuring users can navigate, input, and extract data seamlessly.

As used herein, “data extract configuration” may refer to the systematic process and set of parameters established for retrieving specific data from a source system, database, or application. This configuration delineates the conditions, formats, and structures under which data will be extracted, ensuring that the pulled information is relevant, accurate, and in a usable format for the receiving system or subsequent processes. It encompasses criteria such as data fields, timeframes, and conditions that filter out unnecessary or redundant data. Moreover, data extract configuration often includes settings that govern frequency (e.g., real-time, batch, or scheduled extracts, or the like), error handling procedures, and integration points for the extracted data with other systems or datasets. By defining these parameters, the entity may ensure the consistency, reliability, and efficiency of data extraction tailored to specific operational needs.

As used herein, “parallel processing” refers to a computational technique where multiple tasks or processes are executed concurrently, and in some embodiments simultaneously, to accelerate computational speed and enhance system efficiency. By dividing a larger problem into smaller, independent tasks, parallel processing may enable different parts of a program, or different programs altogether, to be executed at the same time. Typically leveraged in systems with multiple processors or cores, this approach maximizes resource utilization, allowing for faster data processing and task execution. In environments where vast amounts of data need to be processed or complex operations are performed, parallel processing proves instrumental in reducing computational time.

As used herein, “multi-threading” denotes a specialized form of parallel processing where a single program is split into two or more concurrently executing threads. Each thread represents a separate path of execution, and they run in the shared memory space of the program. Multi-threading takes advantage of CPU cores that might otherwise be idle, enhancing the efficiency of applications, especially in situations where multiple tasks are independent and can be performed without waiting for another to complete. In some embodiments, multi-threading may be particularly beneficial in contexts such as user interfaces for data extraction from workflow automation platform architectures, where continued user interaction is necessary even as background tasks proceed, or in server applications that handle multiple requests from users.

As used herein, “proprietary format extracts” may refer to data extraction outputs that are generated and structured in a unique, specialized format exclusive to a particular software, system, or organization. Unlike standard or open formats which are universally recognized and can be accessed by various tools or systems, proprietary format extracts may be designed for specific applications and may require specialized tools or knowledge to interpret, modify, or access. This exclusivity can stem from reasons related to security, or optimization for a particular system performance. Due to a specialized nature, these extracts might present challenges in interoperability with other systems unless appropriate conversion or interface tools are deployed. As such, the present invention allows for a solution to this extraction issue.

As used herein, a “job scheduler node” in the context of parallel processing with multiple threads refers to a dedicated component or unit within a computational system responsible for allocating and managing the execution of tasks across multiple threads or processors. Acting as a central management entity, the job scheduler node assesses the priority, dependencies, and resources required for various tasks. It then orchestrates their execution by determining the optimal thread or processor to handle each task, ensuring maximum utilization and efficiency. In systems with multiple threads or processors, the job scheduler node plays a pivotal role in balancing the workload, preventing bottlenecks, and optimizing throughput. This orchestration ensures that tasks are executed in a synchronized manner, minimizing conflicts and maximizing the concurrent processing benefits. From a software and hardware architecture standpoint, a job scheduler node encompasses various elements. At its core, the job scheduler node requires a sophisticated algorithm that determines the sequence and assignment of tasks based on factors like priority, dependencies, required resources, and deadlines. The job scheduler node may also include a task queue, resource monitor, communication interface, and error handling and recovery mechanisms. The task queue is a structured list where tasks await assignment to specific threads or processors. The scheduler continuously monitors this queue to make assignment decisions.

The resource monitor may include a module which continuously tracks the utilization and availability of computational resources, ensuring that the system does not get overloaded and that tasks are assigned where they can be most efficiently processed. In some embodiments, the job scheduler node needs to communicate with other system components, fetch tasks, send tasks, and receive status updates. This is achieved through well-defined Application Programming Interfaces (APIs) and communication protocols via the communication interface of the node. In any scheduling environment, tasks might fail. As such the job scheduler node software, in exemplary embodiments, can identify these failures, potentially rolling back certain operations, and rescheduling or retrying a task.

The present invention introduces an improved approach to historical data extraction from workflow automation platform architecture. At its core, it employs parallel processing, utilizing a multi-threaded asynchronous tool specifically designed within the workflow automation platform architecture framework. This ensures high performance and scalability, enabling easy extraction of large data volumes within designated system maintenance windows without impinging on system performance. A key highlight is its reusability; the system framework is architected as a modular component within the workflow automation platform architecture, allowing seamless integration into various applications of the same architecture without the necessity for additional coding. From a configurability standpoint, a user interface (UI) has been devised to facilitate the configuration of record extractions per system node, complemented by a bulk upload feature. Monitoring of the process has been simplified with a UI, offering insights into execution metrics such as status, durations, and other relevant data. Additionally, the system boasts an automated notification feature, where email alerts are triggered in the event of data extraction job failures. To further ensure data integrity, a reconciliation report comparing source and destination data is incorporated.

Historically, entities use specialized systems, such as workflow automation platform architectures, to manage and streamline their internal processes. These systems store vast amounts of historical data on how these processes are carried out. This data is a complex digital library of all entity activities in some cases. However, typically these libraries are stored in data formats that are not easy exported or converted to be usable by other processes outside the confines of the workflow automation platform architecture themselves. As such, when entities desire to analyze this historical data to improve their operations, there may be challenges extracting and translating this coded data into a format that is accessible and decipherable by addition programs. Additionally, tracking the export of certain data and ensuring that the data is not extracted in duplicate poses an issue, as the workflow automation platform architecture may not be designed to handle large-scale extractions or parallel extractions in an efficient manner. Thus, entities are left with invaluable insights that may be inaccessible in an unreadable format, hindering their ability to make informed decisions based on past activities.

Addressing these challenges, the solution introduces an advanced tool, specifically engineered to extract this complex data from workflow automation platform architectures. By using sophisticated parallel processing techniques, this tool can access multiple sets of data simultaneously without causing a strain on the system. Additionally, this solution offers a modular framework, and it can be easily adapted and reused for others without significant reconfiguration or coding. To ensure smooth extraction without data redundancy, the tool is equipped with a user-friendly interface that helps entities configure and monitor the extraction process, track real-time metrics, and even alert them if there are any discrepancies or failures. This approach ensures that the once locked-away historical insights can now be accessed, understood, and utilized, allowing for better-informed entity-related decisions.

What is more, the present disclosure provides a technical solution to a technical problem. As described herein, the technical problem includes the challenge of extracting and converting historical data from workflow automation platform architectures into a normalized format suitable for reporting tools and analytics, especially when these architectures store data in proprietary binary formats not readily accessible for large-scale historical analysis. The technical solution presented herein allows for efficient extraction and normalization of large-scale historical data using parallel processing and multi-threading. In particular, the implementation of a job scheduler node, adeptly designed for optimizing parallel extraction tasks from workflow automation platforms, is an improvement over existing solutions to the data extraction and normalization challenge. This solution (i) streamlines the extraction process, conserving valuable computing resources like processing power, storage, and network bandwidth, (ii) yields more accurate data extracts, reducing the potential resource wastage on error corrections, (iii) automates the extraction process, eliminating manual inefficiencies and further saving on computational resources, and (iv) ascertains the optimal allocation of resources for the task, thereby minimizing network congestion and undue strain on computational infrastructure. Moreover, this technical approach employs a precise, computer-driven methodology to undertake tasks not previously executed. In specific implementations, the solution omits redundant steps traditionally employed, leading to even greater resource conservation.

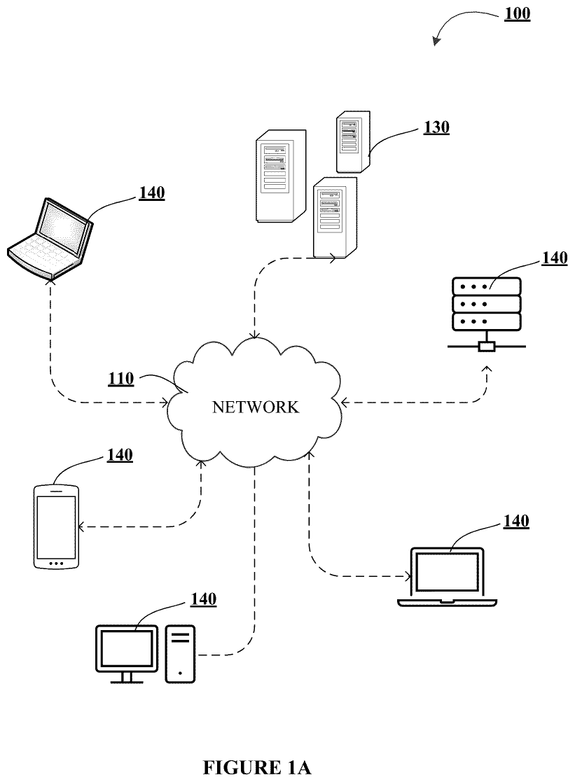

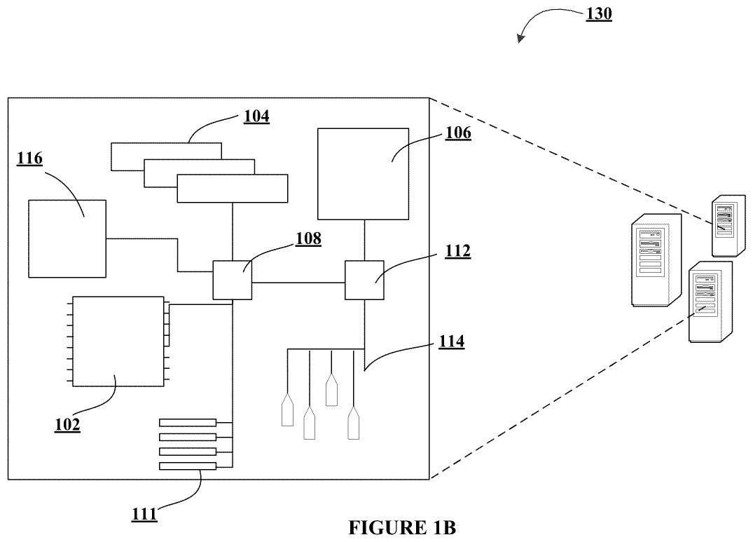

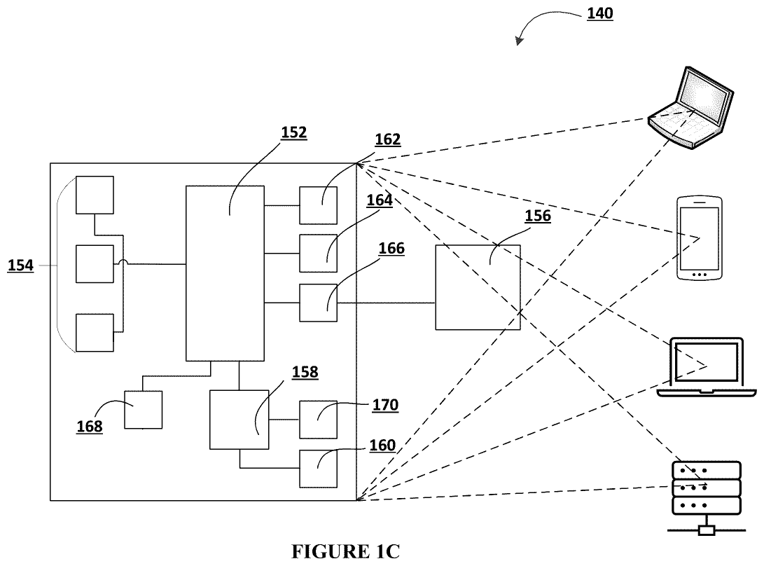

FIGS. 1A-1C illustrate technical components of an exemplary distributed computing environment 100 for extraction of historical data in workflow automation platform architectures, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

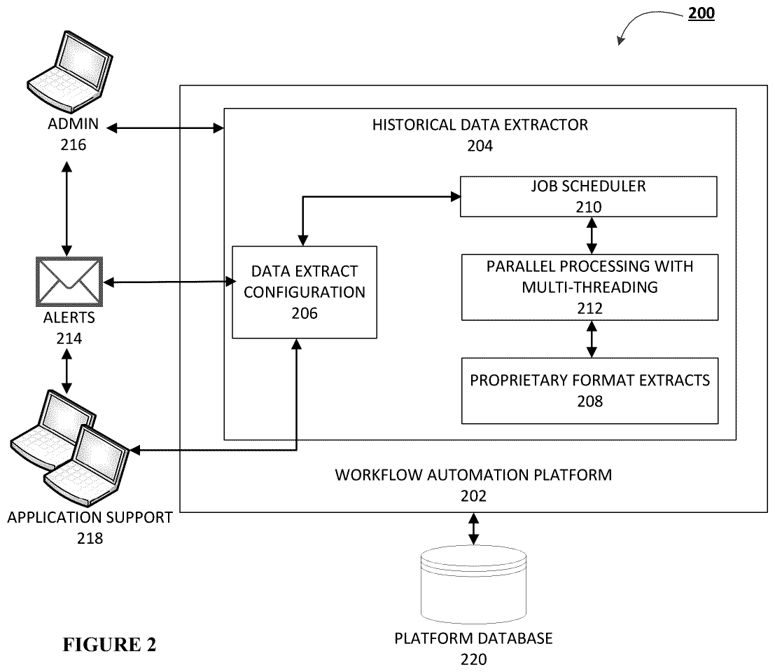

FIG. 2 illustrates a process flow 200 for extraction of historical data in workflow automation platform architectures, in accordance with an embodiment of the disclosure. At the core of process flow 200 in FIG. 2 lies the workflow automation platform 202, a system component designed to streamline and manage various internal processes of an entity. This platform serves as the primary repository for all process-related activities, and importantly, it holds historical data essential for analytical insights. The intrinsic architecture of this platform ensures that data is stored efficiently, albeit in proprietary formats that might pose challenges for traditional extraction methods.

The historical data extractor 204 embedded within the workflow automation platform 202 emerges as a solution to the aforementioned extraction challenges. It is designed with several integral components to enable seamless data extraction and transformation. At its foundation is the data extract configuration 206, which generates and transmits a user-friendly interface, allowing administrators to define specific parameters for data extraction such as time ranges, data types, and extraction frequencies. This component ensures that only relevant data is affected, optimizing the extraction process.

Once data extraction parameters are set, the job scheduler 210 may be utilized. Functioning as the orchestration center for historical data extraction from the workflow automation platform 202, it determines the sequence and prioritization of extraction tasks. Taking into account the volume and complexity of data extracts, the job scheduler allocates tasks to specific threads or processors, leveraging the parallel processing multi-threading 212 engine. The parallel processing multi-threading 212 engine mechanism ensures that multiple data extraction tasks can occur simultaneously, leading to a substantial increase in extraction efficiency.

In some embodiments, given that the data in the workflow automation platform 202 may be originally stored in proprietary formats, the proprietary format extracts 208 are shown downstream of the parallel processing with multi-threading 212. In some embodiments, a specific system module specializes in deciphering and converting the native data formats into more universally accessible and normalized datasets. In some embodiments, transformation is critical, ensuring that the extracted data is readily consumable by external reporting and analytical tools.

To support and oversee the process 200, auxiliary components like the admin device 216, alerts 214, and application support devices 218 are incorporated. the admin device 216 provides a control center for administrators, granting them an overview and control of the entire extraction process. Simultaneously, alerts 214 may be sent via the data extract configuration 206 as to proactively notify admin 216 or application support 218 of any issues or successful completions. The extracted data, once processed, is then stored or further utilized through connections with platform database 220, which serves as a structured repository or a bridge to other systems, ensuring that the invaluable historical insights are securely housed and ready for analysis.

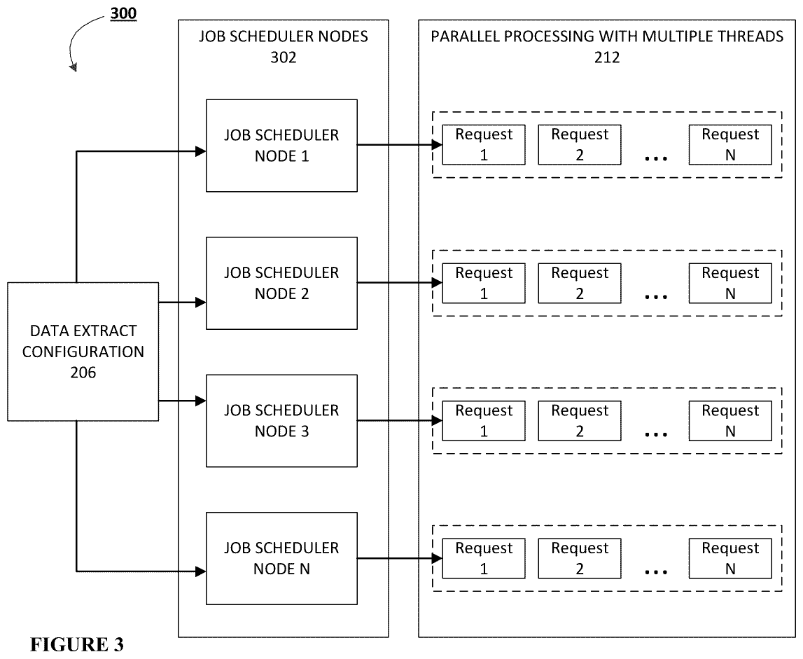

FIG. 3 illustrates a process flow 300 for parallel processing data extraction of historical data in workflow automation platform architectures, in accordance with an embodiment of the disclosure. Central to process flow 300 is the data extract configuration 206. Acting as the blueprint of the extraction process, it communicates specific extraction parameters and instructions to the multiple job scheduler nodes 302 shown in FIG. 3. These instructions can include details on the kind of data to be extracted, the timeframe for which the data is required, and the desired format of the output, or the like. Upon receiving these instructions, each Job Scheduler Node, from Node 1 to Node N, proceeds to generate a set of requests tailored to the configuration's specifications. These requests can be understood as individual tasks or data queries. Given the distributed nature of the system, multiple nodes can work independently and concurrently, breaking down the larger extraction goal into more manageable, smaller tasks.

For instance, in some embodiments, job scheduler node 1 generates a sequence of requests: Request 1, Request 2, through to Request N. In some embodiments, each of these requests might be responsible for extracting a specific subset of data or querying a particular database segment. This pattern is mirrored across job scheduler nodes 2, 3, and all the way up to node N. The modular nature of this system allows for the efficient distribution of tasks and ensures that no two nodes replicate the work of another, creating maximum efficiency and reduced redundancy. Encapsulating all these extraction requests is the parallel processing multi-threading 212 component. This component ensures that multiple requests from various scheduler nodes can be executed simultaneously, in parallel. The parallel processing multi-threading 212 does so by allocating each request to a separate thread or processor. By facilitating simultaneous data extraction, this mechanism significantly reduces the time required to extract vast amounts of data, ensuring the solution's efficacy and efficiency. The parallel processing multi-threading 212 is a sophisticated system that leverages both software and hardware components to optimize data extraction. At the software level, it usually utilizes programming frameworks and libraries designed to facilitate concurrent processing. On the hardware side, it makes use of multi-core processors and potentially even distributed systems to run threads or tasks in parallel. Languages such as Java or C++ have built-in support for multi-threading. In some embodiments, middleware solutions may be utilized to queue tasks and distribute them across multiple processing units or nodes. It is understood that modern CPUs come with multiple cores. Each core can run a separate thread or even multiple threads simultaneously, depending on the architecture. Software-level multi-threading combined with multi-core processors can lead to genuine parallel execution. In some embodiments, the system is configured to optimize data extraction via the parallel processing multi-threading engine 212 via implementing a feedback loop from the multiple job scheduler nodes 302 to adjust thread allocation in real-time, based on system performance metrics and extraction progress.

The feedback loop, which is pivotal to the system's adaptability and efficiency, is established through continuous monitoring and data relay mechanisms. As the multiple job scheduler nodes 302 run tasks, they consistently transmit a stream of performance metrics and extraction progress updates. These metrics might include CPU usage, memory consumption, thread wait times, and any encountered bottlenecks. The feedback loop captures these metrics and routes them to the parallel processing multi-threading engine 212. This engine, using sophisticated algorithms, analyzes the incoming data to make informed decisions in real-time. If a node is underperforming or if there's an unexpected surge in data extraction requirements, the system can adjust thread allocations on-the-fly to meet the dynamic needs. This continuous adjustment ensures that the extraction process remains efficient, minimizing lags and maximizing resource utilization.

In scenarios where data volume is vast, a single machine might not suffice. Systems like cluster computers or cloud computing resources can be harnessed in some embodiments. Distributed systems break down tasks and distribute them across nodes in the cluster, achieving parallelism at a larger scale. To ensure equal distribution of requests and avoid overloading a particular thread or node, load balancers can be integrated in some embodiments. In order that the system is able to track how threads and processes are performing and ensure system health, monitoring tools can be employed in some embodiments. In some embodiments, these tools provide real-time insights and alerts on system performance, ensuring optimal functioning.

In some embodiments, the system is further configured to monitor a status and completion percentage of each of the multiple job scheduler nodes and corresponding data requests in real-time. The system boasts an intricate real-time monitoring mechanism purpose-built to monitor the status and completion percentage of each of the multiple job scheduler nodes as well as their corresponding data requests. This monitoring is more than a mere status check; it is an intelligent, dynamic process that aims to ensure the highest levels of efficiency and reliability throughout the data extraction phase. At the core of this mechanism is a comprehensive dashboard, often accessible through the system's user interface, which provides visualizations, metrics, and logs that administrators and other authorized users can review.

To achieve this real-time monitoring, each job scheduler node is equipped with telemetry and logging capabilities. As these nodes execute their tasks, they continuously transmit a stream of data that encapsulates their current status, errors or exceptions encountered, and the progress percentage of the data requests they're handling. This data is sent to a centralized monitoring module, which then processes and analyzes the information.

For instance, if a node experiences a bottleneck or a delay, the system can detect this deviation in real-time. Based on predefined thresholds and algorithms, the monitoring module can raise alerts or even automatically re-allocate resources to ensure that the affected data requests are processed without significant delays. Moreover, the real-time status updates empower administrators to make informed decisions. If they notice a node consistently underperforming, they could delve deeper to diagnose the issue or route tasks to other more efficient nodes temporarily. This real-time insight into the workflow ensures that the system maintains its ideal level of efficiency.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for extraction of historical data in workflow automation platform architectures, the system comprising:
a processing device;
a non-transitory storage device containing instructions when executed by the processing device, causes the processing device to perform the steps of:
generate a data extract configuration based on received extraction parameters;
initiate multiple job scheduler nodes, each configured to generate and execute a plurality of data requests based on the received extraction parameters;
apply parallel processing multi-threading engine to concurrently process the plurality of data requests;
translate proprietary format extracts into normalized data format extracts; and
store normalized data format extracts in a designated database.

2. The system of claim 1, wherein the system is further configured to optimize data extraction via the parallel processing multi-threading engine via implementing a feedback loop from the multiple job scheduler nodes to adjust thread allocation in real-time, based on system performance metrics and extraction progress

3. The system of claim 1, wherein the system is further configured to monitor a status and completion percentage of each of the multiple job scheduler nodes and corresponding data requests in real-time.

4. The system of claim 1, wherein the system is further configured to trigger automated alerts in case of a data extraction job failure detected during an extraction process.

5. The system of claim 1, wherein the system is further configured to dynamically adjust a total number of active threads or processes based on a current system load and extraction requirements according to the data extract configuration.

6. The system of claim 1, wherein the system is further configured to generate and transmit a user interface, wherein the user interface comprises a status and completion percentage of each of the multiple job scheduler nodes and corresponding data requests in real-time

7. The system of claim 1, wherein the parallel processing multi-threading engine further comprises a distributed cloud computing system enabling a concurrent execution of data extraction tasks across multiple hardware nodes.

8. A computer program product for extraction of historical data in workflow automation platform architectures, the computer program product comprising a non-transitory computer-readable medium comprising code causing an apparatus to:
generate a data extract configuration based on received extraction parameters;
initiate multiple job scheduler nodes, each configured to generate and execute a plurality of data requests based on the received extraction parameters;
apply parallel processing multi-threading engine to concurrently process the plurality of data requests;
translate proprietary format extracts into normalized data format extracts; and
store the normalized data format extracts in a designated database.

9. The computer program product of claim 8, wherein the code further causes the apparatus to: wherein the system is further configured to optimize data extraction via the parallel processing multi-threading engine via implementing a feedback loop from the multiple job scheduler nodes to adjust thread allocation in real-time, based on system performance metrics and extraction progress.

10. The computer program product of claim 8, wherein the code further causes the apparatus to: monitor a status and completion percentage of each of the multiple job scheduler nodes and corresponding data requests in real-time.

11. The computer program product of claim 8, wherein the code further causes the apparatus to: trigger automated alerts in case of a data extraction job failure detected during an extraction process.

12. The computer program product of claim 8, wherein the code further causes the apparatus to: dynamically adjust a total number of active threads or processes based on a current system load and extraction requirements according to the data extract configuration.

13. The computer program product of claim 8, wherein the code further causes the apparatus to: generate and transmit a user interface, wherein the user interface comprises a status and completion percentage of each of the multiple job scheduler nodes and corresponding data requests in real-time

14. The computer program product of claim 8, wherein the parallel processing multi-threading engine further comprises a distributed cloud computing system enabling a concurrent execution of data extraction tasks across multiple hardware nodes.

15. A method for extraction of historical data in workflow automation platform architectures, the method comprising:
generating a data extract configuration based on received extraction parameters;
initiating multiple job scheduler nodes, each configured to generate and execute a plurality of data requests based on the received extraction parameters;
applying parallel processing multi-threading engine to concurrently process the plurality of data requests;
translating proprietary format extracts into normalized data format extracts; and
storing the normalized data format extracts in a designated database.

16. The method of claim 15, wherein the method further comprises: generating and transmitting a user interface to a user device, wherein the user interface comprises a status and completion percentage of each of the multiple job scheduler nodes and corresponding data requests in real-time

17. The method of claim 15, wherein the method further comprises: monitoring a status and completion percentage of each of the multiple job scheduler nodes and corresponding data requests in real-time.

18. The method of claim 15, wherein the method further comprises: triggering automated alerts in case of a data extraction job failure detected during an extraction process.

19. The method of claim 15, wherein the method further comprises: dynamically adjusting a total number of active threads or processes based on a current system load and extraction requirements according to the data extract configuration.

20. The method of claim 15, wherein the parallel processing multi-threading engine further comprises a distributed cloud computing system enabling a concurrent execution of data extraction tasks across multiple hardware nodes.
